(19) United States
(12) Patent Application Publication
(10) Pub. No.: US 2026/0333535 A1
(43) Pub. Date: Oct. 22, 2026

(54) ILLUMINATING DEVICE

(71) Applicant: Domus Line Srl, Porcia (IT)

(72) Inventors: Eliano CHIESURIN, Porcia (PN) (IT); Horst GOTTSCHALK, Rödinghausen (DE)

(21) Appl. No.: 19/122,017

(22) PCT Filed: Oct. 16, 2023
(86) PCT No.: PCT/EP2023/078646

§ 371 Date: May 22, 2025

(30) Foreign Application Priority Data
Oct. 17, 2022 (EP) 22201952.3

(51) Int. Cl. H05B 45/20; H05B 45/10; H05B 45/42; H05B 47/155; H05B 47/185

(52) U.S. Cl. CPC H05B 45/20; H05B 45/10; H05B 45/42; H05B 47/155; H05B 47/185

(57) ABSTRACT

An illuminating device is provided with a circuit board having at least two lighting segments, wach having at least one LED unit of at least one LED. A controller generates different control signals for controlling the LED units (. Via the control signals, the controller can switch the LED units of different lighting segments on and/or off with a temporal offset and change the color temperature and/or the brightness of the generated light. During operation, a transmission cable transmits a voltage curve, which is a direct voltage on which at least one of the control signals of the controller is super-posed, to a filter device, which separates the control signal from the direct voltage and transmits at least the direct voltage to at least one of the LED units and the separated control signal to the microprocessor, which controls the LED unit according to the control signal.

### CROSS REFERENCE

This application claims priority to PCT Application No. PCT/EP2023/078646, filed Oct. 16, 2023, which itself claims priority to European Patent Application No. 22201952.3, filed Oct. 17, 2022, the entireties of both of which are hereby incorporated by reference.

### FIELD OF THE INVENTION

The invention relates to a lighting apparatus. The lighting apparatus comprises a plurality of LEDs, the color temperature and/or brightness of which can be modified by means of a controller. Such a lighting apparatus is known as an LED band in particular.

### BACKGROUND OF THE INVENTION

EP 2 466 996 A2 discloses a luminaire system having a plurality of LED assemblies, the brightness of which is variable. DE 10 2017 124 321 A1 discloses a semiconductor component.

### BRIEF SUMMARY OF THE INVENTION

The problem addressed by the invention is of extending the functional scope of the lighting apparatus with minimal installation space requirements and handling that is as simple as possible.

According to the invention, the problem is solved by a lighting apparatus that comprises a controller, a two-wire transmission line, at least one filter device, at least one microprocessor and a circuit board. The circuit board comprises at least two illuminating segments, each comprising at least one LED unit for generating light. Each LED unit comprises at least one LED. The controller is designed to generate different control signals for controlling the LED units in the illuminated segments. The control signals allow the LED units in different illuminating segments to be switched on and/or off with a time offset by means of the controller. In addition, by means of the controller, the color temperature and/or brightness of the generated light may be modified by the control signals. The transmission line, the filter device and the microprocessor are designed such that, in operation, the transmission line transmits a voltage characteristic, a DC voltage on which at least one of the control signals from the controller has been superimposed, to the filter device, the filter device separates the control signal from the DC voltage, transmits at least the DC voltage to at least one of the LED units and transmits the separated control signal to the microprocessor, which controls the LED unit on the basis of the control signal.

According to the invention, the at least one LED unit of each of the illuminating segments further comprises at least two LEDs. In particular, the at least one LED unit comprises one or more pairs of LEDs. The pairs are formed by a first LED and a second LED. The two LEDs are preferably designed directly adjacent to one another as a compact unit. The first LED has a first color temperature, and the second LED has a second color temperature that deviates from the first color temperature. Due to the differing color temperatures of the first LED and the second LED, the color temperature of the light emitted by the LED unit can be varied, especially while maintaining white light, with the simplest means and with minimal component and space expenditure.

In particular, the circuit board is a rigid or a flexible circuit board. The term “LED” refers to a light-emitting diode. This is a semiconductor device that is designed to emit light. The light-emitting diode usually comprises a semiconductor material and an electrical resistor. Usually, each light-emitting diode is designed to emit light at a certain color temperature, which depends on the semiconductor material.

The LED units are preferably formed exclusively from the LED or LEDs. The LEDs of the lighting apparatus are preferably arranged on the circuit board. Each illuminating segment comprises one LED unit or a plurality of LED units, the latter in particular being controlled uniformly in operation. In the event of a plurality of LED units, these are preferably controlled uniformly, in particular by the same microprocessor, and/or the LED units in the same illuminating segment preferably have the same embodiment. It is particularly preferred for all LED units to have the same embodiment. The illuminating segments preferably have the same number of LED units and have completely the same embodiment, in particular with regard to their components. Each illuminating segment occupies a specific part of the circuit board. By preference, the lighting apparatus comprises at least three, at least five or at least ten illuminating segments.

The controller is a driver in particular. In particular, the controller comprises a processor. The controller is preferably designed to generate the different control signals for controlling all LED units, in particular without controlling these directly. The controller is arranged on the circuit board or at a distance therefrom. The controller serves in particular to encrypt information regarding the possible configurations of the light in the form of the control signals. After selecting a specific intended configuration, the controller generates the control signal associated with the configuration. In particular, the controller superimposes the control signal regarding the voltage characteristic on a DC voltage, in particular the supply voltage, and said controller subsequently transmits this. The filter device lifts the superposition after receiving the voltage characteristic, where-upon the microprocessor decrypts the control signal in order to control the at least one LED unit in accordance with the intended configuration of the light. The filter device enables both the energy supply of the LED unit(s) and the transmission of information regarding the activation thereof, using a transmission line containing only two wires.

The different control signals differ in their purpose. At least one of the control signals serves for the time-offset switch-on and/or switch-off of the LED units in different illuminating segments. At least one additional control signal of said control signals serves to set/modify the color temperature of the light. In an alternative to that or in addition, a further control signal of the control signals serves to set/modify the brightness of the light. In particular, the controller is designed in such a way to generate different control signals that at least three different brightness levels or color temperatures can be set by the control signals. By preference, the color temperature and/or the brightness of the LED units can be modified uniformly in all illuminating segments of the lighting apparatus. This means that the light of all LED units in lighting apparatus always has the same color temperature or brightness in operation.

By preference, the controller is designed to generate a control signal by which the LED units in different illuminating segments can be automatically switched on and/or off with a time offset. This means that the generation and transmission of the control signal to the at least one microprocessor is followed by the time-offset independent switch-on or switch-off, without further intervention by, or further instructions from, the controller. Time-offset switch-on and/or switch-off is intended to refer to the at least one LED unit in a first of the illuminating segments being switched on or off first and the at least one LED unit in a second of the illuminating segments being switched on or off with a time offset, i.e. after a temporal pause, etc. In particular, the time offset or the temporal pause has a length of less than one second, preferably less than one tenth of a second. The temporal pauses between the LED units of more than two illuminating segments being switched on and off have a uniform length in particular. By preference, the controller is designed to generate such different control signals that the temporal pause varies depending on the control signals, wherein said temporal pause within a switch-on or switch-off operation is uniform in turn.

The transmission line has exactly two and not more than two wires, i.e. electrical conductors. The transmission line forms at least a part of the connection between the controller and the filter device. The transmission line serves for communication between the controller and the filter device or the microprocessor. In particular, there is no means of communication in addition to the transmission line between the controller and the filter device or the microprocessor.

The voltage characteristic refers to the time curve of the transmitted voltage. The voltage characteristic should be represented by a V-t curve in particular. As a result of the voltage characteristic, considerable electrical energy for the LEDs and the control signal is transmitted to the filter device at the same time. The superimposed DC voltage is used for the transmission of the electrical energy.

The direct control of the LED units, i.e. the switching on or off and/or the setting or modification of the color temperature or brightness in particular, is implemented, in particular directly implemented, by the at least one microprocessor. The microprocessor is preferably supplied with a DC voltage at a level of five volts, in particular by means of an upstream transistor/voltage regulator. Under certain circumstances, the DC voltage transmitted from the filter device to at least one of the LED units has a lower absolute value than the maximum voltage characteristic received by the filter device. In particular, the controller is supplied with electrical energy by way of a 12 V or 24 V DC voltage. The maximum voltage along the voltage characteristic is, at least substantially, also 12 V or 24 V in particular. The filter device indirectly or directly transmits the DC voltage to the at least one LED unit.

The aforementioned components of the lighting apparatus according to the invention can be present so as to be spatially separated from one another and/or enclosed on an individual basis or collected in part or in full and/or enclosed together. For example, the filter device and the microprocessor may be encompassed by a filter and control device or unit, which adopts the filter and the control function in operation. “Transmit” need not necessarily refer to a complete transmission up to the receiver without passage through intermediate components. In particular, the lighting apparatus is an LED band with a flexible circuit board or a luminaire that is intended for installation in furniture and has a rigid circuit board. The design according to the invention of the lighting apparatus makes it possible to obtain a wide-ranging functional scope while only requiring little installation space for the lighting apparatus and, in particular, achieve temporally successive switch-on or switch-off of the individual light sources.

The claimed lighting apparatus differs from EP 2 466 996 A2 in various features. First, EP 2 466 996 A2 does not disclose a plurality of illuminating segments arranged on the same circuit board. Secondly, EP 2 466 996 A2 does not disclose that the LED assemblies or illuminating segments have LEDs with different color temperatures. According to the invention, the light of the LEDs should be mixed to form light of different color temperatures. These two LEDs allow the illuminating segments to imitate daylight under different conditions, for example while retaining white light. EP 2 466 996 A2, by contrast, considers a reduction in so-called wiring costs and although it describes an option for generating white light, it does not describe an option for changing the color temperature of said light since each LED module generates the same light. DE 10 2017 124 321 A1 should be classified as even more remote.

In particular, the first LED and the second LED are each designed to generate white light. Thus, the invention is distinguished in particular from lighting apparatuses that (exclusively) use colored LEDs, for example for additive color mixing. One of the two white LEDs is preferably designed to generate warm white light, and the other of the two LEDs is preferably designed to generate cold white light. The white light is preferably generated using so-called luminescence, especially in contrast with additive color mixing. When luminescence is used, use is made of an illuminant in particular, which converts initially shorter-wavelength light, for instance bluish light, into white light. Particularly preferably, each LED unit comprises an even number of LEDs. The first LED and the second LED form an LED pair, of which the LED unit has one or more, in particular three to seven.

In particular, the first color temperature deviates from the second color temperature by at least 1000 K, preferably by at least 2000 K and particularly preferably by at least 3000 K. This allows the color temperature to be varied over a particularly broad color temperature range. In particular, the color temperature can be varied from cold-white to warm-white. In a particularly preferred embodiment, the first LED has a color temperature of 2700 K, and the second LED has a color temperature of 6500 K. By preference, the LED units do not comprise LEDs that differ from the first LED and from the second LED in terms of color and/or color temperature.

By preference, the first LED and the second LED are connected in antiparallel and/or are controlled in operation by the same microprocessor. The brightness of the LEDs is usually set by means of pulse width modulation. On the basis of the anti-parallel connection of the first and second LEDs, both the brightness and the color temperature can be set by an extended pulse-width modulation. According to the extended pulse-width modulation, the microprocessor is designed to control the LED unit by means of inverted voltages, i.e. voltages with different signs. For example, the first LED is activated by a control voltage with a positive sign. In this example, the second LED is activated by control voltage with a negative sign. Neither of the two LEDs are activated in the absence of a control voltage. As a result, the fractions of time for which the two LEDs are activated can be varied as required, wherein the two LEDs cannot be activated simultaneously. Varying the fraction of time with no control voltage allows the brightness of the light from the LED unit to be adjusted. The color temperature of the light of the LED unit can be adjusted by varying the ratio of the fraction of time with the positive sign control voltage on the one hand and the fraction of time with the negative sign control voltage on the other.

By preference, each of the illuminating segments comprises at least one micro-processor and/or at least one filter device. The transmission line is particularly preferably designed to transmit the voltage characteristic to the filter device of each of the illuminating segments. In an alternative, the at least one microprocessor or the at least one filter device, respectively as a central microprocessor and central filter device, is assigned to, but not encompassed by, a plurality of illuminating segments. Since each illuminating segment comprises a dedicated microprocessor and/or a dedicated filter device, only the voltage characteristic needs to be transmitted to each illuminating segment via the two-wire transmission line. In particular, the transmission line extends from the controller to all illuminating segments, which are connected in series in particular. This allows the circuit board to be designed to be particularly narrow, and a space advantage that allows the use of the technology according to the invention also in particularly small furniture luminaires can be achieved. Furthermore, this embodiment allows flexible shortening of the length of the circuit board, i.e. a cutting-off of illuminating segments, especially in an embodiment of the lighting apparatus as an LED band, without thereby adversely affecting the function of the remaining illuminating segments.

The microprocessors of the different illuminating segments are particularly preferably at least configured differently in such a way that they switch on the at least one LED unit of their respective illuminating segment with a different time delay even when they receive the same control signal serving for a switch-on. The delay shall be understood in relation to the reception and/or generation or transmission of the control signal. This embodiment means that the microprocessors interpret the same control signal differently. This means that a certain switch-on sequence of the LED units of the different illuminating segments can be achieved for example as a result of the transmission of only one control signal. In an alternative to that or in addition, the above applies to the switch-off.

The circuit board preferably extends longitudinally. In particular, this means that the circuit board, apart from its thickness, has an extent in a longitudinal direction that is at least five times greater, particularly preferably at least ten times greater, than its extent transverse to the longitudinal direction. The extent transverse to the longitudinal direction is preferably no more than 12 mm, particularly preferably no more than 10 mm, 8 mm, 7 mm or 6 mm. The illuminating segments are arranged offset from one another in the longitudinal direction of the circuit board. In particular, the illuminating segments are directly adjacent to one another or preferably uniformly spaced apart from one another. By preference, the illuminating segments are arranged in a single row in a manner offset in the longitudinal direction, i.e. no illuminating segments are arranged in a manner offset transversely to the longitudinal direction. The extent of the illuminating segments in the longitudinal direction is at least substantially uniform in particular and/or is no more than 75 mm in particular, preferably no more than 50 mm, and/or at least 10 mm.

The circuit board preferably extends at least substantially or at least proportionally in ring-shaped, rectangular, U-shaped, L-shaped or I-shaped (i.e. straight) fashion. This means that the longitudinal direction optionally varies along the longitudinal extent of the circuit board. In the case of a ring-shaped circuit board, the longitudinal direction is the circumferential direction, for example.

The at least one microprocessor or the totality of the microprocessors is preferably designed to successively switch on the LED units in the illuminating segments in the order of arrangement of the illuminating segments in the longitudinal direction, based on the control signal generated for the time-offset switch-on. From an optical point of view, this brings about a successive/migrating switched-on light of the lighting apparatus. In an alternative to that or in addition, the microprocessor or the totality thereof is designed to successively switch off the LED units in the illuminating segments in the reverse order of arrangement of the illuminating segments in the longitudinal direction, based on a control signal generated for the time-offset switch-off. As a result, the same effect albeit in the reverse direction can be achieved during switch-off. In particular, the sequence or direction of switching on the LED units or the time difference between switch-ons of the individual LED units can be varied on the basis of the control signal.

The at least one microprocessor is preferably designed to identify all control signals to be generated by the controller and/or identify at least three, preferably at least five and particularly preferably at least ten different control signals. In particular, the same selection of control signals for encrypted transmission between the at least one microprocessor and the controller is stored in both of said devices. The at least one microprocessor and the controller access the same library as a result. The greater the selection of the control signals, the more comprehensively the functional scope of the lighting apparatus should be designed.

The voltage characteristic is preferably composed particularly exclusively of first sections, in which the voltage is constant at the magnitude of a nominal voltage >0 V, and of second sections. In the second sections, the voltage is constant at, in particular, the magnitude of an intermediate voltage that is lower than the nominal voltage and >0 V. In an alternative, there is no voltage in the second sections. The voltage thus alternates along the voltage characteristic between the nominal voltage and intermediate voltage or absence of voltage. The timing of the changes and/or the length of the sections encrypts the information about the configuration of the light for control.

The at least one filter device is preferably designed such that the DC voltage transmitted in operation to at least one of the LED units has a smoothed characteristic, in particular a second-section-free characteristic, in comparison with the voltage characteristic transmitted to the filter device. To this end, the filter device preferably comprises a smoothing device. In this context, the term DC voltage must not be interpreted strictly in the sense of a strictly constant magnitude of the voltage. The voltage might vary at least to a small extent but not change sign. The DC voltage does not vary over time or at least varies to a lesser extent than the voltage in accordance with the voltage characteristic. The freedom from second sections should be understood to mean that the DC voltage remains permanently >0 volts.

The lighting apparatus preferably comprises a trigger device that is coupled to the controller in wired or wireless fashion and designed to trigger the generation of at least one of the control signals, in particular all of the control signals, by the controller. In particular, the trigger device is arranged locally removed from the controller. Particularly preferably, the trigger device comprises a user-operated remote control that is mobile relative to the controller in particular. In particular, the remote control comprises at least one first button for triggering the generation of a control signal for the time-offset switch-on and/or switch-off, at least one second button for triggering the generation of a control signal for modifying the color temperature and/or at least one further button for triggering the generation of a control signal for modifying the brightness. In particular, the remote control in each case has two buttons or a key combination both for triggering the generation of a control signal for modifying the color temperature and for triggering the generation of a control signal for modifying the brightness. In an alternative, the remote control has a touch screen for triggering purposes. In an alternative to the remote control, the trigger device preferably is a motion detector or any other type of sensor. The different functions of the lighting apparatus can be used particularly easily in this way.

By preference, the lighting apparatus comprises a ballast for supplying the controller with electrical energy. The ballast is in particular designed to transform AC voltage from a power grid, in particular with a nominal voltage of 230 V, to DC voltage, in particular with a nominal voltage of 12 V or 24 V. In particular, the ballast comprises a plug for connecting the lighting apparatus to the household power grid. This renders the lighting apparatus mobile and easy to use anywhere in the home.

By preference, the LED units of the illuminating segments are arranged on a front side of the circuit board, and the at least one filter device and/or the at least one microprocessor are arranged on a back side of the circuit board. In the case of a plurality of filter devices and/or microprocessors, these are in particular arranged at least in part, in particular in their entirety (in the sense of the totality thereof) on the back side of the circuit board. A further installation space advantage can be achieved as a result.

The invention also includes the method for operating the aforementioned lighting apparatus. Accordingly, the controller generates a control signal for the time-offset switch-on and/or switch-off of the LED units of different illuminating segments, for the purpose of modifying the color temperature and/or for purpose of modifying the brightness of the generated light. The transmission line then transmits the voltage characteristic, a DC voltage on which the control signal from the controller has been superimposed, to the filter device. The filter device separates the control signal from the DC voltage and (indirectly or directly) transmits at least the DC voltage to at least one of the LED units. Moreover, the filter device transmits the separated control signal to the microprocessor. The microprocessor controls the LED unit on the basis of the control signal.

### BRIEF DESCRIPTION OF THE DRAWINGS

Reference is now made more particularly to the drawings, which illustrate the best presently known mode of carrying out the invention and wherein similar reference char-acters indicate the same parts throughout the views.

FIG. 1 shows a schematic illustration of the structure of a first lighting apparatus according to an example embodiment of the invention.

FIG. 2 shows a schematic illustration of the structure of a second lighting apparatus according to an example embodiment of the invention.

FIG. 3 shows an illustration of a front side of a circuit board of a third lighting apparatus according to an example embodiment of the invention.

FIG. 4 shows an illustration of a back side of the circuit board of the third lighting apparatus according to an example embodiment of the invention.

### DETAILED DESCRIPTION OF THE DRAWINGS

The features of the exemplary embodiments according to the invention that are explained below may also be subject matter of the invention individually or in combinations other than those presented or described. Where expedient, functionally identical parts are denoted by identical reference signs.

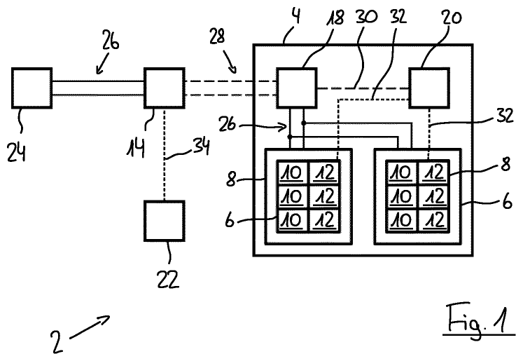

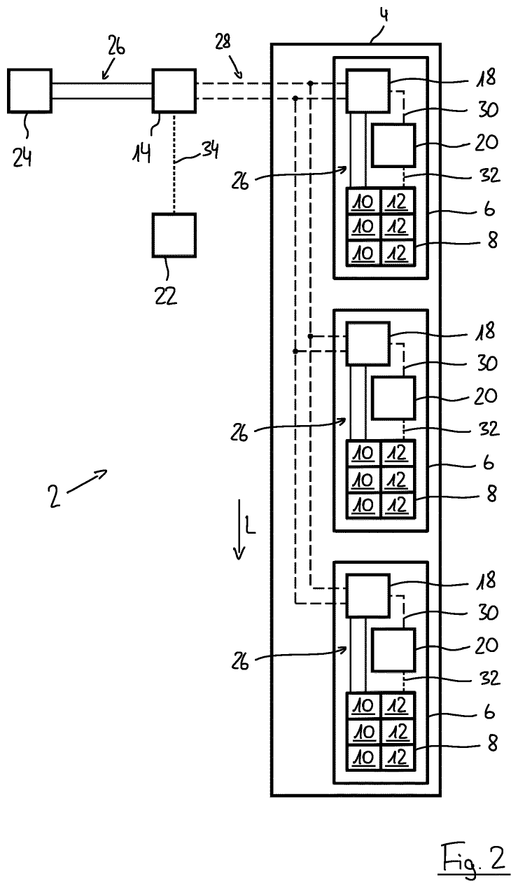

FIGS. 1 and 2 show different lighting apparatuses 2 according to the invention, the similarities of which are initially described below. The lighting apparatuses 2 each have a circuit board 4 with a plurality of illuminating segments 6 that each comprise an LED unit 8 for generating light. Each LED unit 8 in turn comprises 3 pairs of LEDs 10, 12, with each pair comprising a first LED 10 and a second LED 12.

The lighting apparatuses 2 each comprise a respective controller 14, which is designed to generate different control signals 30 for controlling the LED units 8 in the illuminating segments 6. The control signals 30 allow the LED units 8 to be switched on and off in a time-offset manner, allow the color temperature to be modified and allow the brightness of the generated light to be modified.

A trigger device 22 that is designed to trigger the generation of control signals 30 by the controller 14 is connected to the controller 14 in wireless fashion. To this end, the trigger device 22 transmits a trigger signal 34 in operation. The controller 14 is supplied with electrical energy in the form of direct current 26 by means of a ballast 24. The controller 14 generates a DC voltage 28 on which the control signal 30 is superimposed. The voltage characteristic of the DC voltage 28 is transmitted by the controller 14 to the at least one filter device 18 of the lighting apparatus 2 by means of a two-wire transmission line 16 that is not shown in FIGS. 1 and 2.

The at least one filter device 18 serves to separate the control signal 30 from the DC voltage 26 from the superimposed DC voltage 28. The DC voltage 26 is transmitted by the at least one filter device 18 to at least one of the LED units 8. The separated control signal 30 is transmitted to the at least one microprocessor 20, which is designed to control at least one of the LED units 8 on the basis of the control signal 30. To this end, the microprocessor 20 transmits a control signal 32 to the at least one LED unit 8.

The exemplary embodiments according to the invention in FIGS. 1 and 2 differ in particular with regard to the arrangement of the at least one filter device 18 and the at least one microprocessor 20. The exemplary embodiment according to FIG. 1 comprises a filter device 18 and a microprocessor 20 that are arranged on the circuit board 4 and process the superimposed DC voltage 28 for all illuminating segments 6. Among other things, this means that the microprocessor 20 sends the control signal 32 to all LED units 8 in the different illuminating segments 6.

In contrast, the exemplary embodiment according to the invention in FIG. 2 comprises a filter device 18 and a microprocessor 20 per illuminating segment 6. The filter devices 18 and microprocessors 20 are part of the illuminating segments 6 and adopt the processing of the superimposed DC voltage 28 only for the—in this case one—LED unit 8 of the respective illuminating segment 6. The superimposed DC voltage 28 must therefore be transmitted from the controller 14 to all illuminating segments 6. For the respective LED units 8, the superimposed DC voltage 28 or the control signal 30 contained therein is interpreted, in particular interpreted differently, by the microprocessors 20.

The circuit board 4 of the second exemplary embodiment of the lighting apparatus 2 according to the invention extends longitudinally in a longitudinal direction L. The illuminating segments 6 are arranged offset in the longitudinal direction L. Depending on the control signal 30, the LED units 8 of the illuminating segments 6 are successively switched on in the order of arrangement of the illuminating segments 6 in the longitudinal direction L or switched off in the reverse order.

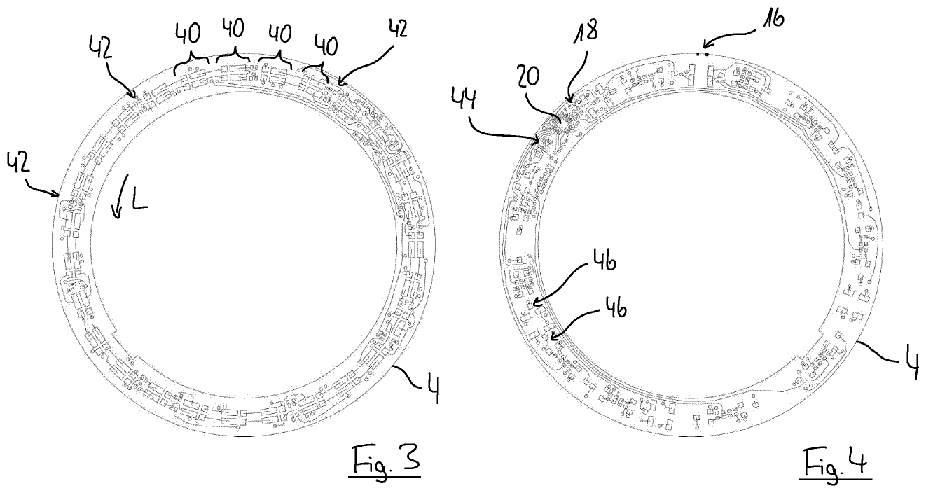

FIGS. 3 and 4 show the different sides of a circuit board 4 of a third exemplary embodiment. The circuit board 4 extends in elongate ring-shaped fashion (cf. longitudinal direction L). A plurality of pairs 40 of a first LED 10 and a second LED 12 (only labeled in part), which together form the same LED units 8, are arranged on the front side. Series resistors 42 (again only labeled in part) are assigned to the pairs. A microprocessor 20, a voltage regulator 44 for the microprocessor 20, a filter device 18, an input of the transmission line 16 and LED transistors 46 in each case assigned to one of the pairs 40 are arranged (again only labeled in part) on the back side.

1. A lighting apparatus, comprising:
a circuit board having at least two illuminating segments, each illuminating segment comprising at least one LED unit that comprises at least one LED for generating light, wherein the at least one LED unit of each of the illuminating segments comprises one or more pairs of a first LED which has a first color temperature, and a second LED which has a second color temperature that deviates from the first color temperature;
a controller that generates different control signals for controlling the LED units in the illuminating segments, wherein by way of control signals, the LED units of different illuminating segments are switched on and/or off with a time offset and the color temperature and/or the bright-ness of the generated light are modified by the controller;
a two-wire transmission line;
at least one filter device; and
at least one microprocessor;
wherein the transmission line transmits a voltage characteristic, a DC voltage on which at least one of the control signals from the controller has been superimposed, to the filter device,
wherein the filter device separates the control signal from the DC voltage,
wherein the filter device transmits at least the DC voltage to at least one of the LED units and transmits the separated control signal to the microprocessor, and
wherein the microprocessor controls the LED unit based on the control signal.

2. The lighting apparatus as claimed in claim 1, wherein the first LED and the second LED are each capable of generating white light.

3. The lighting apparatus as claimed in claim 1, wherein the first color temperature deviates from the second color temperature by at least 1000 K.

4. The lighting apparatus as claimed in claim 1, wherein the first LED and the second LED are connected in antiparallel and controlled by the same microprocessor.

5. The lighting apparatus as claimed in claim 1, wherein each of the illuminating segments comprises at least one microprocessor and/or at least one filter device, and the transmission line transmits the voltage characteristic to the filter device of each of the illuminating segments.

6. The lighting apparatus as claimed in claim 5, wherein the microprocessors in the different illuminating segments are configured differently.

7. The lighting apparatus as claimed in claim 1, wherein the circuit board extends longitudinally, and the illuminating segments are arranged offset from one another in a longitudinal direction (L) of the circuit board.

8. The lighting apparatus as claimed in claim 7, wherein the at least one microprocessor successively switches on the LED units in the illuminating segments in an order of arrangement of the illuminating segments in the longitudinal direction (L), based on the control signal generated for the time-offset switch-on, and/or successively switches off the LED units in the illuminating segments in reverse order of arrangement of the illuminating segments in the longitudinal direction (L), based on the control signal generated for the time-offset switch-off.

9. The lighting apparatus as claimed in claim 1, wherein the microprocessor identifies all control signals to be generated by the controller and/or identify at least three different control signals.

10. The lighting apparatus as claimed in claim 1, wherein the voltage characteristic is composed of first sections, in which the voltage is constant at the magnitude of a nominal voltage >0 V, and of second sections, in which the voltage is constant or in which no voltage is applied.

11. The lighting apparatus as claimed in claim 1, wherein the DC voltage transmitted to at least one of the LED units has a smoothed characteristic in comparison with the voltage characteristic transmitted to the filter device.

12. The lighting apparatus as claimed in claim 1, wherein further comprising a trigger device that is coupled to the controller in wired or wireless fashion to trigger generation of one of the control signals by the controller.

13. The lighting apparatus as claimed in claim 12, wherein the trigger device comprises a user-operated remote control that is mobile and comprises at least one first button for triggering the generation of a control signal for the time-offset switch-on and/or switch-off, at least one second button for triggering the generation of a control signal for modifying the color temperature and/or at least one further button for triggering the generation of a control signal for modifying the brightness.

14. The lighting apparatus as claimed in claim 1, further comprising a ballast that supplies the controller with electrical energy and transforms AC voltage from a power grid to direct current.

15. The lighting apparatus as claimed in claim 1, wherein the LED units of the illuminating segments are arranged on a front side of the circuit board, and the at least one filter device and/or the at least one micro-processor are/is arranged at least in part on a back side of the circuit board.

16. The lighting apparatus as claimed in claim 6, wherein the microprocessors in the different illuminating segments switch on the at least one LED unit in the respective illuminating segment with a different time delay upon reception of the same control signal.

17. The lighting apparatus as claimed in claim 10, wherein in the second sections the magnitude of an intermediate voltage is lower than the nominal voltage, or no voltage is applied.

18. The lighting apparatus as claimed in claim 11, wherein the DC voltage transmitted to at least one of the LED units has a gap-free characteristic in comparison with the voltage characteristic transmitted to the filter device.

19. The lighting apparatus as claimed in claim 14, wherein the ballast that supplies the controller with electrical energy and transforms AC voltage from a power grid with a nominal voltage of 230 V, to direct current with a nominal voltage of 12 V or 24 V.

20. The lighting apparatus as claimed in claim 15, wherein the at least one filter device and/or the at least one micro-processor are/is arranged in full on the back side of the circuit board.
